(19) United States
(12) Patent Application Publication
(10) Pub. No.: US 2023/0045756 A1
(43) Pub. Date: Feb. 9, 2023

(54) METHOD FOR TRACKING AND MANAGING A POWER SUPPLYING DEVICE VIA A BLOCKCHAIN-BASED SYSTEM

(71) Applicant: EBATTE HOLDINGS LIMITED, Hong Kong (CN)

(72) Inventor: Yuen Hung, Hong Kong (CN)

(21) Appl. No.: 17/793,035

(22) PCT Filed: Feb. 10, 2021
(86) PCT No.: PCT/CN2021/076606

§ 371 Date: Jul. 15, 2022

Related U.S. Application Data
(60) Provisional application No. 62/984,794, filed on Mar. 4, 2020.

(51) Int. Cl. G06Q 50/06; H02J 7/00; G06Q 20/38; G06Q 20/40

(52) U.S. Cl. CPC G06Q 50/06; H02J 7/0068; G06Q 20/389; G06Q 20/4014; G06Q 20/403

(57) ABSTRACT

The present invention provides a method for tracking and managing power supplying devices and a blockchain-based system to perform such tracking and monitoring. The method comprises the steps of retrieving recorded characteristic data that is associated with an existing product identification from a blockchain, verifying such recorded characteristic data, generating a new product identification that is connected to the existing product identification and recording the new product identification and new characteristic data in the blockchain. The system comprises a blockchain and a middleware computer to perform the above-mentioned steps. Also provided herein is a blockchain-based system for monitoring and renting a power supplying device.

### CROSS-REFERENCE TO RELATED APPLICATIONS

This is a U.S. national stage application of the International Patent Application No. PCT/CN2021/076606, filed Feb. 10, 2021, which claims the benefit under 35 U.S.C. § 119(e) of U.S. Provisional Patent Application No. 62/984,794, filed Mar. 4, 2020, the content of which is incorporated herein by reference in its entirety.

### FIELD OF THE INVENTION

The present disclosure relates to systems and methods for monitoring, renting, recycling and transacting power supplying devices, using a blockchain. The present invention also relates to systems and methods for determining prices for the power supplying devices.

### BACKGROUND OF THE INVENTION

In light of the rapid popularization of digital devices and electric vehicles, as well as increasing efforts towards energy conservation, power supplying devices and the batteries they contain play an increasingly important role.

Despite the rise in popularity of the power supplying devices, only a very small percentage of used devices is traded or recycled. These devices often end up neglected in a drawer or sent to a landfill, and both the production and the disposal of devices produce large amounts of waste, significantly damaging the environment. Reasons for the low trading and recycling rate include an absence of systems designed for trading or recycling and a low level of awareness on battery recycling programs.

Another major obstacle to establishing recycling schemes for power supplying devices is the lack of infrastructure to track and monitor the life cycle of such power supplying devices. Setting up a tracking system that monitors and records production and usage history of the devices would be very useful to battery recyclers as it would allow recyclers to be certain about the characteristics and quality of the batteries that they recycle.

Such information would also make the life cycle of a power supplying device more transparent, allowing consumers to understand and verify the environmental impact of each stage of the device's life cycle (e.g. manufacturing, packaging, use, recycling). This would make consumers more aware of the benefits they bring to the environment by recycling their power supplying devices and incentivize them to do so.

Further incentive to recycle could be provided if consumers were given money or credits for the power supplying devices they recycle, and it would be preferable if the amount of money or credits paid were decided according to the condition of the battery inside the power supplying device. Other parties participating in the life cycle of the power supplying devices, such as battery recyclers, manufacturers, retailers etc., could also be incentivized to purchase and sell recycled batteries or battery materials by being rewarded with money or credit whenever they do so.

However, until now, there had been no available databases that permit an owner, user or buyer to assess the condition of the battery based on its history, and assign a monetary value to the battery based on such an assessment. The parties involved in the trading of used batteries do not have sufficient information in determining a value of the particular battery and are only limited to generic valuations (i.e. a base price) based primarily on the model and year of the battery, hampering trading of second-hand batteries. The actual value of used batteries varies based upon market conditions and battery characteristics such as the specifications of the battery or battery condition.

A tracking and monitoring system as described above could be further be adapted to gather information on the status and history of a battery, including details on physical parameters, such as the number of charge/discharge cycles used, that can be used to determine the condition of the battery. Such information could then be used as a basis for assigning a monetary value to batteries, facilitating and incentivizing recycling of power supplying devices and solving the problem highlighted above. Systems to accommodate other methods of reducing waste from and encouraging reuse of power supplying devices (e.g. renting or trading power supplying devices instead of disposing them) can also utilize such information to determine the health of the battery and assign a monetary value for such transactions accordingly.

US Patent Publication No. 2019/0197608 A1 discloses a storage battery rental system. The system comprises a determining unit that determines an incentive for renting a particular battery, wherein various factors, e.g. supply and demand of batteries at a certain location and battery consumption history, play a role in determining the value of the incentive and a different incentive value may be provider to different users. However, the system lacks a way to fully assess the condition of the battery and evaluate a price for the battery that would encourage users to recycle unwanted batteries.

Another problem is securing the data stored in the database for battery valuation, which are vulnerable to cybersecurity attacks, physical attacks or malicious operators within the network. In a world where technological advancement allows growing data networks and integration of everyday electronics, data security is essential and steps should be taken to ensure the stored data cannot be altered or falsified.

In addition, although rental power supplying devices such as mobile power sources are becoming increasingly popular, one of the problems with existing rental systems is that these systems lack the ability to reliably and accurately monitor the health and performance of the power supplying devices and ensure that users can rent power supplying devices of good quality.

In order to best manage the power supplying devices and encourage their recycling and reuse, it would be advantageous to monitor the behavior of the power supplying devices to predict battery failure and keep record of other battery performance or status parameters related to battery health or performance so that users can be informed of the state of health of these power supplying devices and action can be taken ahead of time to ensure that any problems are addressed.

There is a need, therefore, for a low-cost, reliable and accurate battery monitoring system and a method for unmanned monitoring of batteries to estimate battery health to encourage users to recycle them. In addition, there is also a need for a system and method in which battery price is evaluated based on battery history without requiring the consumer to provide battery information.

### SUMMARY OF THE INVENTION

The aforementioned needs are met by various aspects and embodiments disclosed herein. In one aspect, provided herein is a method for managing a power supplying device on a blockchain-based system, the method comprising:

(a) inputting a user identification, an existing product identification and a data retrieval instruction to a middleware computer;

(b) verifying the user identification via the middleware computer;

(c) retrieving, from existing blocks in a blockchain ledger, one or more virtual folders that are associated with the product identification;

(d) transmitting the one or more virtual folders to the middleware computer;

(e) extracting recorded characteristic data from the one or more virtual folders using the middleware computer;

(f) verifying the recorded characteristic data;

(g) inputting new characteristic data into the middleware computer;

(h) generating, via the middleware computer, a new product identification that is connected to the existing product identification;

(i) linking, via the middleware computer, the new product identification and the new characteristic data to form a new virtual folder;

(j) transmitting the new virtual folder from the middleware computer to the blockchain ledger; and

(k) creating a new block in the blockchain ledger to record the new virtual folder.

In another aspect, the present invention provides a blockchain-based tracking system for managing a power supplying device, comprising:

a blockchain, and

one or more middleware computers that are capable of:
receiving one or more virtual folders from a blockchain;
extracting recorded characteristic data from the one or more virtual folders;
verifying a user identification and the recorded characteristic data;
generating a new product identification that is connected to an existing product identification;
linking the new product identification and new characteristic data to form a new virtual folder;
transmitting the new virtual folder to the blockchain; and
creating a new block in the blockchain to record the new virtual folder.

In yet another aspect, the present invention provides a blockchain-based renting and monitoring system for a power supplying device comprising:

a blockchain ledger;

a middleware server configured to transmit data to and receive data from the blockchain ledger;

a mobile terminal comprising a renting module configured to transmit an instruction to the middleware server to rent the power supplying device; and

a power supplying device comprising:
a battery;
a monitoring module coupled to the battery and configured to monitor one or more battery operation parameters;
a main controller coupled to the monitoring module and configured to calculate one or more battery status parameters using the one or more battery operation parameters received from the monitoring module; and
a communication module coupled to the main controller and configured to transmit the one or more battery operation parameters and battery status parameters to the middleware server.

### BRIEF DESCRIPTION OF THE DRAWINGS

FIG. 1 shows a schematic representation of an embodiment of a blockchain-based tracking system for managing a power supplying device.

FIG. 2 shows a schematic representation depicting an embodiment of a method for tracking and managing a power supplying device.

FIG. 3 shows a schematic representation of an embodiment of a system comprising a blockchain for renting, monitoring and recycling a power supplying device.

FIG. 4 shows a schematic representation depicting an embodiment of a middleware server system.

FIG. 5 shows a schematic representation depicting an embodiment of a power supplying device comprising a battery.

FIG. 6 shows a schematic representation depicting an embodiment of a power supplying device comprising a plurality of batteries.

FIG. 7 is a flow chart of an embodiment illustrating the steps for processing and storing monitored parameters of a power supplying device.

FIG. 8 is a flow chart of an embodiment illustrating the steps for recycling a power supplying device.

FIG. 9 is a flow chart of an embodiment illustrating the steps for renting a power supplying device.

FIG. 10 is a flow chart of an embodiment illustrating the steps for returning a power supplying device.

FIG. 11 is a flow chart of an embodiment illustrating the steps for purchasing a power supplying device.

FIG. 12 is a schematic representation depicting a system for the trading or consecutive rental of a power supplying device.

FIG. 13 is a screenshot of the graphic user interface that shows some battery operation and status parameters such as battery capacity, battery temperature and indicator of battery safety.

### DETAILED DESCRIPTION OF THE INVENTION

### General Definitions

The term “battery operation parameter” refers to any information or data that may be used by the evaluation module for its processing. The battery operation parameters may include the type of battery (model and year) and any other parameters such as number of charging/discharging cycles and any of the battery history data.

The term “battery status parameter” refers to any information or data that may be calculated by the evaluation module using battery operation parameters. The battery status parameters may include battery level, state of charge of the battery and cumulative charging and discharging capacities.

The term “blockchain” (also “blockchain network” and “blockchain ledger” herein) is a distributed database that maintains a continuously growing list of data records. In general, blockchain technology creates a secure ledger that records events or transactions and distributes the ledger across multiple nodes in a network, ensuring that transactions on the network are transparent and auditable. The blockchain cryptographically secures information in the network and can be configured such that the ledger cannot be altered even by entities who have access to the network.

The term “maximum continuous discharging current” refers to the maximum current that a power supplying device or electrochemical cell at a fully-charged state can be discharged at a voltage that is equal to or higher than the nominal voltage of the power supplying device or electrochemical cell.

The term “maximum pulse discharging current” refers to the maximum current that a power supplying device or electrochemical cell at a fully-charged state can be discharged at a voltage that is equal to or higher than the nominal voltage of the power supplying device or electrochemical cell over a short period of time, e.g. 3 seconds, 5 seconds or 10 seconds.

The term “nominal voltage” refers to the (rated) voltage across the terminals of an electrochemical cell or a power supplying device when it is loaded, and specifically refers to the average voltage on the plateau of the discharge curve of the electrochemical cell or power supplying device.

The term “state of charge” (SOC) refers to the level of charge of a power supplying device or electrochemical cell relative to its capacity. A fully charged power supplying device or electrochemical cell has an SOC of 100%, while a fully discharged one has an SOC of 0%.

The term “state of health” (SOH) refers to a parameter that characterizes the overall condition of a power supplying device or electrochemical cell, relative to its ideal or initial condition. SOH may take into account any number of parameters of the power supplying device or electrochemical cell, such as the capacity retention, length of use, number of charge/discharge cycles used and performance history of the power supplying device or electrochemical cell.

Unless otherwise stated, language using singular forms should not be interpreted to exclude embodiments with plural forms. For example, where the singular article “a” or “an” is used in the present disclosure, it should be understood to include both singular and plural forms.

Where a numerical range is provided herein, any interval within such numerical range is also disclosed. Any specific value within such numerical range is also disclosed.

As described more fully below, the present invention provides an effective system and method for monitoring the production, use, recycling and other stages of the life of a power supplying device. In particular, it provides a robust system for monitoring power supplying devices to facilitate their recycling and further using the monitored information to determine the value of a particular power supplying device, all of which work to encourage recycling and reuse of power supplying devices to reduce the negative environmental impact that results from their disposal. The present invention also provides an effective system and method for calculating price values for the power supplying device based on its history. Correspondingly, the present invention solves the problems of the prior art in this aspect.

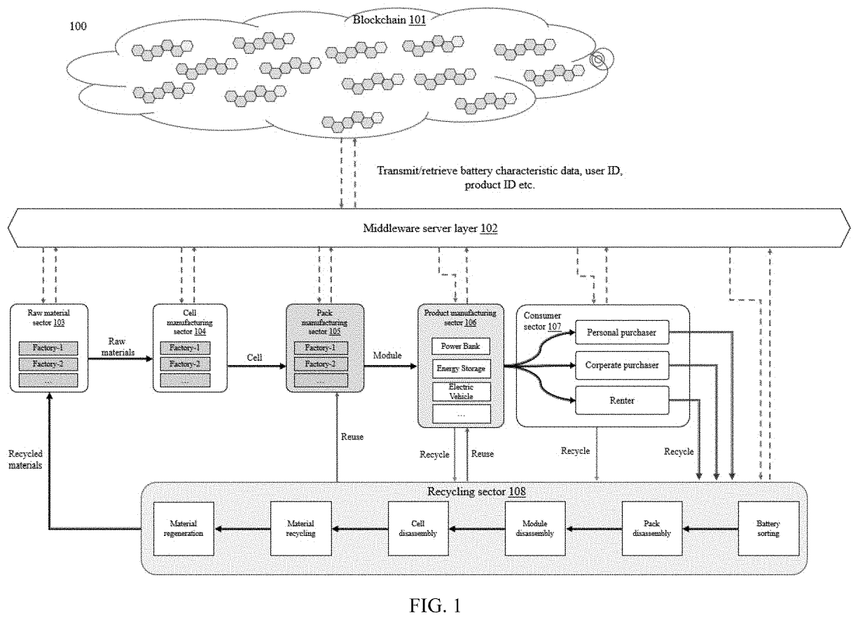

FIG. 1 is a schematic representation of the integration of a blockchain-based management system with the life cycle of power supplying devices, including their manufacturing, use and recycling, according to an embodiment of the present invention. The different stages of the life cycle of a power supplying device may be best conceptualized in sectors, with each sector roughly representing a stage in the life cycle, such as recycling, manufacturing, consumption etc. Within each sector there are many users, i.e. entities that perform the task of that sector. For example, in the recycling sector, a user may be a recycling company, while in the consuming sector, a user may be an ordinary consumer of a power supplying device.

In this system, each sector can communicatively interact with a blockchain network 101 through a middleware layer 102. As the power supplying device is being manufactured, recycled or otherwise transferred between the sectors (represented by solid lines in FIG. 1), each sector can transmit and receive information on one or more characteristics of products (hereinafter “characteristic data”) and other necessary information (flow of information is represented by the dashed lines in FIG. 1) to and from the blockchain 101. It should be noted that the sectors mentioned herein are not exhaustive; other sectors may be identified within the life cycle of the power supplying device. Similarly, characteristic data may still be collected in sectors that are not elaborated upon in the description below.

The middleware layer 102 refers to the network of virtual processes (and the hardware in which they are housed, including computers, servers, smartphones and other electronic devices that can act as an interface between users and the blockchain) that act as a link between the user interface and the blockchain 101. The middleware layer 102 can transmit instructions and data it receives from the users or sectors to the blockchain and relay data and signals it receives from the blockchain to the users or sectors. The middleware layer 102 may be divided into nodes, each designed to store, process and/or transmit a certain type of data and/or instructions, e.g. an evaluation node to store, process and/or transmit data that is used to evaluate the sale price of the power supplying device. It should be understood that references to a middleware computer 102 below should not be restricted to mean a personal computer or laptop, but should be extended to mean any electronic device, including but not limited to tablets and smartphones, that can be programmed to perform the functions described below.

The raw material sector 103 produces raw materials for the manufacturing of battery cells. During production, characteristic data of the raw materials can be collected and transmitted to the blockchain network through a middleware computer 102. In some embodiments, the characteristics of the raw materials may include the type of raw material, the source of raw material and manufacturing conditions.

In some embodiments, the type of raw material can be a cathode material. In certain embodiments, the type of raw material can be a metal salt comprising a metal selected from the group consisting of Fe, Mn, Al, Mg, Zn, Ti, La, Ce, Sn, Zr, Ru, Cr, Ni, Co, alkaline earth metals, transition metals and combinations thereof. In certain embodiments, the metal is selected from the group consisting of Fe, Mn, Al, Mg, Zn, Ti, La, Ce, Sn, Zr, Ru, Cr, Ni, Co and combinations thereof. In some embodiments, the metal is selected from the group consisting of Fe, Al, Mg, Ce, La, Cr, Ni, Co and combinations thereof. In certain embodiments, the metal salt comprises an anion selected from the group consisting of chloride, iodide, bromide, nitrate, sulfate, sulfite, phosphate, chlorate, acetate, formate and combinations thereof.

In some embodiments, the type of raw material can be an anode material. In certain embodiments, the anode active material is selected from the group consisting of graphite, natural graphite particulate, synthetic graphite particulate, hard carbon, mesophase carbon, mesocarbon microbeads (MCMB), Sn (tin) particulate, SnO₂, SnO, Li₄T₁₅O₁₂ particulate, Si (silicon) particulate, Si—C composite particulate and combinations thereof.

In some embodiments, the type of raw material can be a current collector. In certain embodiments, the current collector is a cathode current collector or an anode current collector. In some embodiments, the current collector can be in the form of a foil, sheet or film. In certain embodiments, the current collector is made from, titanium, nickel, aluminum, copper or electrically-conductive resin. In certain embodiments, the cathode current collector is an aluminum thin film. In some embodiments, the anode current collector is a copper thin film.

In the cell manufacturing sector 104, cell components, such as cathodes, anodes, separators, electrolytes etc., can be produced and assembled into battery cells. During cell manufacturing, characteristic data of one or more of the cathodes, anodes, separators, electrolytes and battery cells can be evaluated and transmitted to the blockchain network 101 through a middleware computer 102. Some non-limiting examples of the characteristic data of the battery cell include cell manufacturing date, cell manufacturing time, cell manufacturing location, cell cathode type, cell cathode model, cell anode type, cell anode model, separator type, electrolyte model, cell type, cell length, cell width, cell thickness, cell weight, cell voltage, cell nominal capacity, open circuit voltage, cell tested capacity, cell maximum charging current, cell maximum continuous discharging current, cell maximum pulse discharging current, cell discharging cut-off voltage, cell initial internal resistance, cell maximum working temperature, cell connection in pack and combinations thereof. In some embodiments, the cathodes, anodes, separators and/or battery cells are manufactured via a process that ensures the power supplying device is recyclable. In certain embodiments, the cathodes, anodes, separators, electrolytes and/or battery cells are manufactured via a water-based process using aqueous chemicals.

In some embodiments, the cathode material is selected from the group consisting of LiCoO₂, LiNiO₂, LiNiₓMn_{y}O₂, LiCoₓNi_{y}O₂, Li_{1+z}NiₓMn_{y}Co_{1-x-y}O₂, LiNiₓCo_{y}Al_{z}O₂, LiV₂O₅, LiTiS₂, LiMoS₂, LiMnO₂, LiCrO₂, LiMn₂O₄, Li₂MnO₃, LiFeO₂, LiFePO₄, and combinations thereof, wherein each x is independently from 0.1 to 0.9; each y is independently from 0 to 0.9; each z is independently from 0 to 0.4. In certain embodiments, each x in the above general formula is independently selected from 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875 and 0.9; each y in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875 and 0.9; each z in the above general formula is independently selected from 0, 0.025, 0.05, 0.075, 0.1, 0.125, 0.15, 0.175, 0.2, 0.225, 0.25, 0.275, 0.3, 0.325, 0.35, 0.375 and 0.4. In some embodiments, each x, y and z in the above general formula independently has a 0.01 interval.

In certain embodiments, the cathode material is selected from the group consisting of LiCoO₂, LiNiO₂, LiNiₓMn_{y}O₂, Li_{1+z}NiₓMn_{y}Co_{1-x-y}O₂ (NMC), LiNiₓCo_{y}Al_{z}O₂, LiV₂O₅, LiTiS₂, LiMoS₂, LiMnO₂, LiCrO₂, LiMn₂O₄, LiFeO₂, LiFePO₄, LiCoₓNi_{y}O₂, and combinations thereof, wherein each x is independently from 0.4 to 0.6; each y is independently from 0.2 to 0.4; and each z is independently from 0 to 0.1. In other embodiments, the cathode material is not LiCoO₂, LiNiO₂, LiV₂O₅, LiTiS₂, LiMoS₂, LiMnO₂, LiCrO₂, LiMn₂O₄, Li₂MnO₃, LiFeO₂, or LiFePO₄.

In further embodiments, the cathode material is not LiNiₓMn_{y}O₂, Li_{1+z}NiₓMn—_{y}Co_{1-x-y}O₂, LiNiₓCo_{y}Al_{z}O₂ or LiCoₓNi_{y}O₂, wherein each x is independently from 0.1 to 0.9; each y is independently from 0 to 0.45; and each z is independently from 0 to 0.2. In yet further embodiments, the cathode material is not LiNi_{0.33}Mn_{0.33}Co_{0.33}O₂, LiNi_{0.4}Mn_{0.4}Co_{0.2}O₂, LiNi_{0.5}Mn_{0.3}Co_{0.2}O₂, LiNi_{0.6}Mn_{0.2}Co_{0.2}O₂, LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂, LiNi_{0.92}Mn_{0.04}Co_{0.04}O₂, or LiNi_{0.8}Co_{0.15}Al_{0.05}O₂.

In certain embodiments, the cathode material is Li₁₊ₓNiₐMn_{b}Co_{c}Al_{(1-a-b-c)}O₂; wherein −0.2≤x≤0.2, 0≤a≤1, 0≤b≤1, 0≤c≤1, and a+b+c≤1. In some embodiments, the cathode material has the general formula Li₁₊ₓNiₐMn_{b}Co_{c}Al_{(1-a-b-c)}O₂, with 0.33≤a≤0.92, 0.33≤a≤0.9, 0.33≤a≤0.8, 0.4≤a≤0.92, 0.4≤a≤0.9, 0.4≤a≤0.8, 0.5≤a≤0.92, 0.5≤a≤0.9, 0.5≤a≤0.8, 0.6≤a≤0.92, or 0.6≤a≤0.9; 0≤b≤0.5, 0≤b≤0.4, 0≤b≤0.3, 0≤b≤0.2, 0.1≤b≤0.5, 0.1≤b≤0.4, 0.1≤b≤0.3, 0.1≤b≤0.2, 0.2≤b≤0.5, 0.2≤b≤0.4, or 0.2≤b≤0.3; 0≤c≤0.5, 0≤c≤0.4, 0≤c≤0.3, 0.1≤c≤0.5, 0.1≤c≤0.4, 0.1≤c≤0.3, 0.1≤c≤0.2, 0.2≤c≤0.5, 0.2≤c≤0.4, or 0.2≤c≤0.3. In some embodiments, the cathode material has the general formula LiMPO₄, wherein M is selected from the group consisting of Fe, Co, Ni, Mn, Al, Mg, Zn, Ti, La, Ce, Sn, Zr, Ru, Si, Ge and combinations thereof. In some embodiments, the cathode material is selected from the group consisting of LiFePO₄, LiCoPO₄, LiNiPO₄, LiMnPO₄, LiMnFePO₄, LiMn_{d}Fe_{(1-d)}PO₄ and combinations thereof; wherein 0≤d≤1. In some embodiments, the cathode material is LiNiₑMn_{f}O₄; wherein 0.1≤e≤0.9 and 0≤f≤2. In certain embodiments, the cathode material is dLi₂MnO₃.(1-d)LiMO₂, wherein M is selected from the group consisting of Ni, Co, Mn, Fe and combinations thereof; and wherein 0≤d≤1. In some embodiments, the cathode material is Li₃V₂(PO₄)₃, LiVPO₄F. In certain embodiments, the cathode material has the general formula Li₂MSiO₄, wherein M is selected from the group consisting of Fe, Co, Mn, Ni, and combinations thereof.

In certain embodiments, the cathode material is doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the dopant is not Co, Cr, V, Mo, Nb, Pd, F, Na, Fe, Ni, Mn, Mg, Zn, Ti, La, Ce, Ru, Si, or Ge. In certain embodiments, the dopant is not Al, Sn, or Zr.

In some embodiments, the cathode material is LiNi_{0.33}Mn_{0.33}Co_{0.33}O₂ (NMC333), LiNi_{0.4}Mn_{0.4}Co_{0.2}O₂, LiNi_{0.5}Mn_{0.3}Co_{0.2}O₂ (NMC532), LiNi_{0.6}Mn_{0.2}Co_{0.2}O₂ (NMC622), LiNi_{0.7}Mn_{0.15}Co_{0.15}O₂, LiNi_{0.7}Mn_{0.1}Co_{0.2}O₂, LiNi_{0.8}Mn_{0.1}Co_{0.1}O₂ (NMC811), LiNi_{0.92}Mn_{0.04}Co_{0.04}O₂, LiNi_{0.8}Co_{0.15}Al_{0.05}O₂ (NCA), LiNiO₂ (LNO), and combinations thereof.

In certain embodiments, the cathode material comprises or is a core-shell composite having a core and shell structure, wherein the core and the shell each independently comprise a lithium transition metal oxide selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, LiCoₐNibO₂, LiMnₐNibO₂, and combinations thereof; wherein −0.2≤x≤0.2, 0≤a≤1, 0≤b≤1, 0≤c≤1, and a+b+c≤1. In certain embodiments, each x in the above general formula is independently selected from −0.2, −0.175, −0.15, −0.125, −0.1, −0.075, −0.05, −0.025, 0, 0.025, 0.05, 0.075, 0.1, 0.125, 0.15, 0.175 and 0.2; each a in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95 and 0.975; each b in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95 and 0.975; each c in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95 and 0.975. In some embodiment, each x, a, b and c in the above general formula independently has a 0.01 interval. In other embodiments, the core and the shell each independently comprise two or more lithium transition metal oxides. In some embodiments, one of the core or shell comprises only one lithium transition metal oxide, while the other comprises two or more lithium transition metal oxides. The lithium transition metal oxide or oxides in the core and the shell may be the same, or they may be different or partially different. In some embodiments, the two or more lithium transition metal oxides are uniformly distributed over the core. In certain embodiments, the two or more lithium transition metal oxides are not uniformly distributed over the core. In some embodiments, the cathode material is not a core-shell composite.

In some embodiments, each of the lithium transition metal oxides in the core and the shell is independently doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In certain embodiments, the core and the shell each independently comprise two or more doped lithium transition metal oxides. In some embodiments, the two or more doped lithium transition metal oxides are uniformly distributed over the core and/or the shell. In certain embodiments, the two or more doped lithium transition metal oxides are not uniformly distributed over the core and/or the shell.

In some embodiments, the cathode material comprises or is a core-shell composite comprising a core comprising a lithium transition metal oxide and a shell comprising a transition metal oxide. In certain embodiments, the lithium transition metal oxide is selected from the group consisting of Li₁₊ₓNiₐMn_{b}Co_{c}Al_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMoS₂, LiCoₐNibO₂, LiMnₐNi_{b}O₂, and combinations thereof; wherein −0.2≤x≤0.2, 0≤a≤1, 0≤b≤1, 0≤c≤1, and a+b+c≤1. In certain embodiments, x in the above general formula is independently selected from −0.2, −0.175, −0.15, −0.125, −0.1, −0.075, −0.05, −0.025, 0, 0.025, 0.05, 0.075, 0.1, 0.125, 0.15, 0.175 and 0.2; each a in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95 and 0.975; each b in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95 and 0.975; each c in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875, 0.9, 0.925, 0.95 and 0.975. In some embodiment, each x, a, b and c in the above general formula independently has a 0.01 interval. In some embodiments, the transition metal oxide is selected from the group consisting of Fe₂O₃, MnO₂, Al₂O₃, MgO, ZnO, TiO₂, La₂O₃, CeO₂, SnO₂, ZrO₂, RuO₂, and combinations thereof. In certain embodiments, the shell comprises a lithium transition metal oxide and a transition metal oxide.

In some embodiments, the core and the shell each independently comprise two or more lithium transition metal oxides. In some embodiments, one of the core or shell comprises only one lithium transition metal oxide, while the other comprises two or more lithium transition metal oxides. The lithium transition metal oxide or oxides in the core and the shell may be the same, or they may be different or partially different. In some embodiments, the two or more lithium transition metal oxides are uniformly distributed over the core. In certain embodiments, the two or more lithium transition metal oxides are not uniformly distributed over the core. In some embodiments, the cathode material is not a core-shell composite.

In pack manufacturing sector 105, the battery cells can be assembled into battery packs. Meanwhile, characteristic data of the battery packs can be collected and transmitted to the blockchain network via a middleware computer 102.

Some non-limiting examples of the characteristic data include pack manufacturing date, pack manufacturing time, pack manufacturing location, pack casing material, pack-cell assembly type, pack length, pack width, pack thickness, pack weight, pack voltage, pack initial capacity, pack maximum charging current, pack maximum continuous discharging current, pack maximum pulse discharging current, pack discharging cut-off voltage, pack maximum working temperature, pack initial internal resistance and combinations thereof.

In the product manufacturing sector 106, battery packs/cells can be arranged into power supplying devices. During manufacturing, characteristic data of the power supplying devices can be collected and transmitted to the blockchain network 101 through a middleware computer 102. Some non-limiting examples of the characteristic data of the power supplying devices include the battery module identification, battery pack identification, battery cell identification, the type of the power supplying device, the brand of the power supplying device and the manufacturer of the power supplying device.

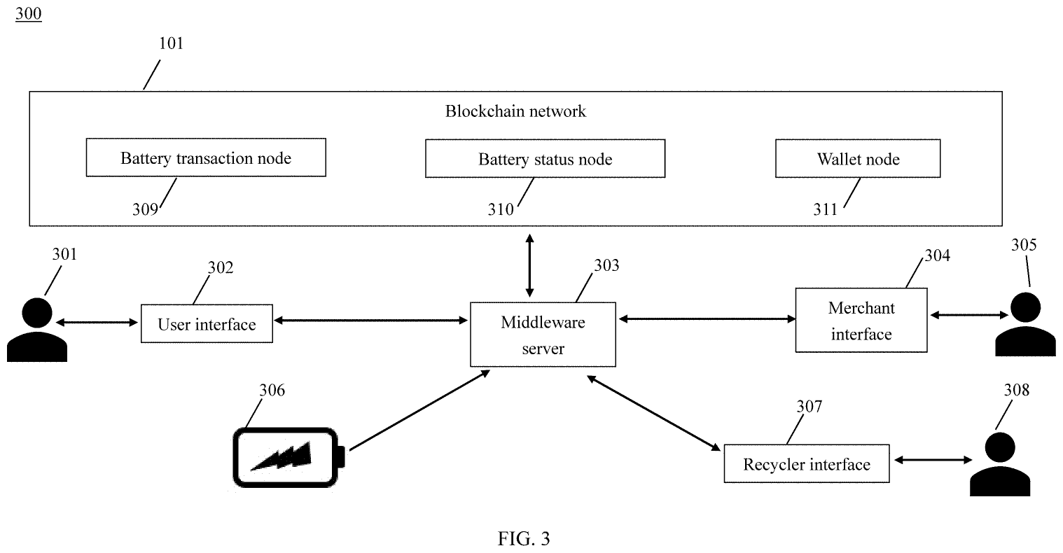

In the consumer sector 107, finished power supplying devices can be rented/purchased and used by consumers. Such consumers may be an individual person, a company or a group of people or companies. During the consumers' use of the power supplying device, characteristic data may be collected and transmitted to the blockchain network 101 through a middleware computer 102. FIGS. 3-13 describe embodiments of a monitoring system that can perform this data collection and transmission process and can use such data to calculate a monetary value to assign to the renting, purchase or recycling of the power supplying device. Some non-limiting examples of the characteristic data may include total number of charge/discharge cycles, total time in charging process, safety inspection information, error/fault history, product recall history, number of owners, state of charge, state of health, initial capacity cumulative charging and discharging capacities, physical parameters (e.g. temperature, voltage, pressure), manufacturer information, date of manufacture, type, size and length of use of the power supplying device.

In the recycling sector 108, spent and waste power supplying devices are received from the consumer sector 107. The power supplying devices are disassembled and treated to form regenerated components and materials that can be used in other sectors to form new power supplying devices. During the recycling process, characteristic data of the power supplying device or any intermediate recycling products can be collected and transmitted to the blockchain network 101 through a middleware computer 102. Some non-limiting examples of the characteristic data include the type, size, composition, source, purity, information the recycling process(es) used and previous owner information of the power supplying device or intermediate recycling product.

It should be noted that the sectors do not have to be delineated or defined in the same way as the embodiment shown in FIG. 1. Each sector may comprise more or fewer steps and users as shown in FIG. 1, or the steps and users may be grouped into sectors in a different manner as shown in FIG. 1. For example, while the steps of material regeneration and battery sorting are grouped with the recycling sector 108 in the embodiment shown in FIG. 1, these steps could instead be performed by the raw materials sector 103 and the consumer sector 107 respectively.

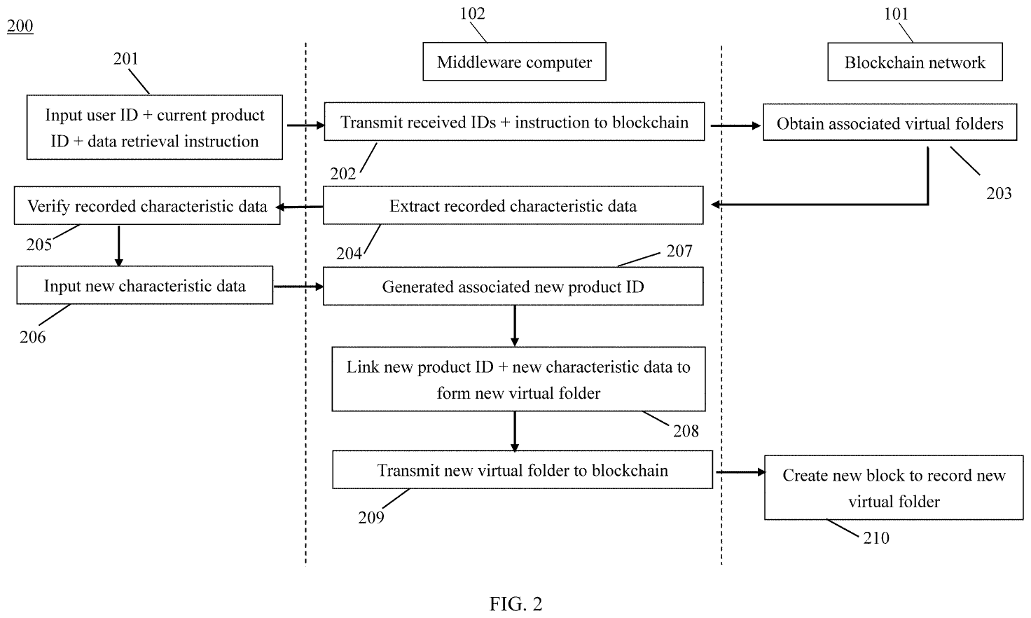

FIG. 2 describes a method 200 for monitoring the life cycle of a power supplying device, according to one embodiment of the invention. As demonstrated in FIG. 1, each sector represents a stage in the life cycle of a power supplying device and in each sector a device or a component thereof is being created or transformed to enter the next stage of the life cycle. The method 200 described below gives an example of how the characteristics collected in each sector can be integrated into the blockchain.

The method 200 can be summed up as follows. In each sector, an existing product arrives from the previous sector and is transformed into a new product that will be used in the next sector to continue the life cycle of the power supplying device. For example, a recycler obtains used power supplying devices from consumers and processes the devices to form recycled materials that can be sold to the raw materials sector for their further processing, and so on until the power supplying device goes through its life cycle and starts again. When the user of the current sector has completed transforming the existing product into the new product intended for the next sector, the user can compile new characteristic data of the new product, as exemplified in the description of FIG. 1 above. The user can then transmit the new data to the blockchain 101, and the blockchain can then create a new block in the blockchain ledger to record the new data of the new product. A detailed description of the method 200 is provided below.

An existing product from the previous sector arrives at the current sector. The existing product is associated with an existing product identification, which uniquely identifies the existing product and may encode information about the existing product. In some embodiments, the existing product identification may include references to information about the existing product's source, the type of the existing product (e.g. battery, raw material, recycled material etc.), the existing product's manufacturing date and time and/or physical parameters like the existing product's weight and dimensions. In some embodiments, the existing product identification is in the form of a code that can be scanned or read by a machine, such as a barcode or a QR code. In certain embodiments, the code containing the existing product identification is printed on the body and/or the packaging of the product.

Often it would be useful or even necessary for the user to verify one or more characteristics of the existing product before the user performs the work of the current sector to make a new product (e.g. recycling power supplying devices for the recycling sector, or assembling batteries into battery packs for the pack manufacturing sector). For example, a recycler might want to verify that a power supplying device they have bought does contain only chemicals that are recyclable. Once the work of the current sector is complete and a new product is formed, the user may want to provide other sectors with information on the new product, so that a detailed record can be kept and can be accessed by any user in the system 100. The method 200 described below allows the user to easily access past data of the existing product and to easily record the characteristic data of the new product on the blockchain for all other sectors to see and use as they may need.

A user of the current sector can scan or otherwise input the existing product identification into a middleware computer 102. The user may also input a user identification, i.e. an identification code belonging to the user, into the middleware computer 102, simultaneously with or separately from the inputting of the existing product identification. In some embodiments, the user identification may include the user's personal information, e.g. the user's name and contact information, or include references to such personal information. In other embodiments, the user identification does not bear any reference to or association with the user's personal information. In certain embodiments, the user identification may be randomly generated, such that the user identification cannot be traced back to an individual. In some embodiments, the user identification may not be the same each time the same user uses the method 100.

The middleware computer 102 can then verify the user identification to obtain the user's identity. In some embodiments, the transmission containing the existing product identification and user identification may also comprise a data retrieval instruction for the blockchain to retrieve one or more virtual folders from an existing block in the blockchain ledger.

A virtual folder refers to a collection of related pieces of data. These pieces of data may include without limitation a user identification, a product identification, characteristic data of the product associated with the product identification, and a timestamp of the transmission of the data to the blockchain. There are no particular restrictions on how the different pieces of data are to be recognized by the blockchain and/or the middleware computer 102 as related to each other to form the virtual folder. In some embodiments, the virtual folder may be formed by cryptographically linking the different pieces of data. In other embodiments, the virtual folder may simply be created by having the pieces of data stored adjacent to each other.

The blockchain can then retrieve the virtual folder or folders that correspond to the existing product identification. Where an instruction to retrieve one or more specific virtual folders was also transmitted, the blockchain 101 only retrieves the virtual folder or folders specified. The blockchain can then transmit the retrieved virtual folders to the middleware computer 102.

In some embodiments, the user identification comprises a user classification that encodes the sector of the user, e.g. recycler, raw materials manufacturer, consumer etc. and the middleware computer 102 is capable of reading the user classification associated therewith. Using the user classification, the middleware computer 102 can determine the user's access restrictions, i.e. find out the virtual folders that the user has permission to access, and only the virtual folders which are accessible under the user's access restrictions would be retrieved. Applying access restrictions can be advantageous to safeguarding the privacy of all users of the system; for example, users can be refused access to the personal information of other users. By restricting the number of folders retrievable through such an arrangement, it may also improve the efficiency of the retrieval process of the virtual folders.

Once received, the virtual folders can be read by the middleware computer 102 to extract the characteristic data stored within (the “recorded characteristic data”). The recorded characteristic data can include without limitation all the characteristics mentioned in the description of the various sectors of FIG. 1. In some embodiments, the recorded characteristic data comprises a product source, a product brand, a product type, a product size or combinations thereof. In some embodiments, the user may send an instruction to the middleware computer 102, instructing it to selectively extract certain recorded characteristic data. In other embodiments, all the recorded characteristic data in the virtual folder or folders may be extracted and shown to the user. In certain embodiments, access to recorded characteristic data in the retrieved virtual folders may also be restricted by the access restrictions of the user classification and the middleware computer 102 may extract only the characteristic data that is accessible. Such an arrangement may be useful, e.g., when the recorded characteristic data includes trade secrets, confidential information or other information that would benefit from not being disclosed publicly.

The user may then determine the corresponding characteristics of the existing product and verify the characteristic data determined (the “current characteristic data”) against the recorded characteristic data. This allows the user to verify that the current product is indeed the same product as recorded into the blockchain by the previous sector. In some embodiments, the verification step is performed by the middleware computer 102. In other embodiments, the verification step is performed by hand or by non-electronic equipment. In certain embodiments, after the verification step is performed, a verification result is produced and transmitted to the blockchain to be recorded there.

The current product is then processed to form a new product. Once the new product is formed, the user may determine characteristic data of the new product (the “new characteristic data”). In some embodiments, the new characteristic data that is to be determined from the new product is decided according to a predetermined list. This can ensure uniformity in the information between different batches of the same type of product, or potentially between different sectors. The predetermined list may be the same for each sector, or it may be different. In some embodiments, the same predetermined list is used for two or more sectors, while other sectors have a different predetermined list or lists.

In other embodiments, the user is free to choose what characteristic data to determine. This would give the user the most freedom and potentially lower the costs of determining such characteristics, since the user chooses the number and types of characteristics to determine. In yet other embodiments, the user must determine a predetermined list of characteristic data, but is free to determine additional characteristic data. Such an approach would give the user a large amount of freedom while also allowing all users from all sectors to have access to the maximum amount of information possible. In some embodiments, the new characteristic data comprises a product source, a product brand, a product type, a product size or combinations thereof.

The user may then input the new characteristic data into the middleware computer 102. The middleware computer 102 can subsequently, based on the existing product identification, generate a new product identification that will be associated with the new product. In some embodiments, the new product identification is formed from the existing product identification by adding further information. In other embodiments, the new product identification is formed by combining portions of the existing product identification with new identification material. In certain embodiments, the new product identification can also take into account and reflect the user identification and/or other data. In other embodiments, the new product identification may deliberately be devoid of any reference to the user identification for reasons such as data protection and privacy.

The middleware computer 102 can then link the new characteristic data and the new product identification together to form a new virtual folder. In some embodiments, the virtual folder further comprises the user identification. In other embodiments, the virtual folder may deliberately be devoid of any reference to the user identification for reasons such as data protection and privacy. Once the new virtual folder is formed, it can be transmitted by the middleware computer 102 to the blockchain so that a new block containing the new virtual folder can be created to record the new virtual folder in the blockchain ledger.

In further embodiments, an incentive, in the form of physical currency, digital currency, credits, points or any other reward, can be provided to the user for using the method 200 and contributing to the blockchain. In some embodiments, the reward is issued to the user upon the verification result being recorded on the blockchain ledger. This would provide an incentive for users to perform the verification step, thereby maintaining a complete history and making sure that users of later sectors can refer to it. In some embodiments, the reward is issued to the user after the new virtual folder is recorded on the blockchain. In certain embodiments, the reward may be issued after any other step of the method 200.

The method 200 allows easy recording of and access to all data that could be collected during the life cycle. Through the blockchain system, all users in the different sectors can have access and add to the production and use history of the power supplying devices and their components, all under the security provided by the blockchain. Thus, the method allows the different sectors to easily verify the characteristics and the products they buy and sell. As a result, consumers are more likely to recycle or reuse their power supplying devices because of the trust that is forged by this method. Overall, the method 200 encourages all users to minimize disposal of power supplying devices by keeping the devices within the system 100, thereby reducing their environmental impact. The best-case scenario would be the formation of a closed-loop system, in which power supplying devices are efficiently recycled into raw materials that are then made into power supplying devices again.

Some of the tracking and monitoring needs presented above can be fulfilled by an automated system that monitors different parameters of a power supplying device, estimates the health of the power supplying device using such parameters and uploads such data to the blockchain for recordation in real time. These parameters and health information can further be used to generate a fair rental or sale price for the power supplying device based on the device's health and history records.

FIG. 3 shows a schematic representation of a system for monitoring, renting and recycling of a power supplying device according to an embodiment of present invention. A user 301 may rent, return or recycle a power supplying device 306 via the system 300. FIG. 3 may also be viewed as showing the relationship of different entities potentially involved in the application of the present invention. In some embodiments, the power supplying device 306 is a mobile power source such as a power bank or a vehicle battery module. The system can operate automatically or autonomously in a secure fashion.

In some embodiments, system 300 comprises a user interface 302, a middleware server 303, a merchant interface 304, and a recycler interface 307. In some embodiments, the system 300 does not comprise a recycler interface 307. In some embodiments, the user interface 302, merchant interface 304 or recycler interface 307 is a mobile electronic device, such as a cell phone, laptop or tablet.

The middleware server 303 may be configured to process and store data regarding the monitoring, renting and recycling of a power supplying device 306. The power supplying device 306 may contain a monitoring system to monitor and/or calculate various parameters regarding the status or health of the power supplying device. The power supplying device 306 may be configured to evaluate and monitor its own status or health via the monitoring system and transmit relevant information or parameters to the middleware server 303. In some embodiments, the middleware server 303 may be configured to store, transmit and receive data such as user identification information, transaction records and other account information between the user interface 302, merchant interface 304 and recycler interface 307 to permit renting and recycling of the power supplying device 306. In certain embodiments, such data may be encrypted for enhanced data security, and the encryption may be performed by the middleware server 303 and/or the power supplying device 306.

The user interface 302, merchant interface 304 and recycler interface 307 are communicatively coupled to the middleware server 303. The user 301, representing an individual consumer, as well as the merchant 305 and the recycling dealer 308, can access battery history and transaction history information recorded in the middleware server 303 and blockchain 101, as discussed more fully herein below. The battery history and transaction history information may include information such as the rental value, recycling price, sale price and past status information of a particular power supplying device 306. In some embodiments, the user 301, the merchant 305 and the recycling dealer 308 may access such battery and transaction history information via the user interface 302, the merchant interface 304 and the recycler interface 307 respectively. In certain embodiments, the system 300 may further comprise a buyer interface that is communicatively coupled to the middleware server 303 configured to allow a buyer to access past records stored in the middleware server regarding the use, status and value of the power supplying device 306.

The middleware server 303 is capable of transmitting the data and signals it receives to a blockchain network 101 and receiving data and signals from a blockchain 101 to record and retrieve health information on a particular power supplying device 306.

The blockchain network 101 may comprise one or more nodes. In some embodiments, the blockchain network 101 may comprise a battery transaction node 309, battery status node 310 and/or wallet node 311. The battery transaction node 309 may be configured to receive and store transaction records, such as records of rental, purchase or recycling of the power supplying device 306. The battery status node 310 may be configured to receive and store status information of the power supplying device, such as battery operation and status parameters. The wallet node 311 may be configured to receive and store financial information of users' 301 accounts. In some embodiments, the wallet node receives and stores the financial information in such way that it is not possible to determine the user's 301 identity from the financial information or other information recorded on the blockchain alone.

In certain embodiments, the blockchain network 101 may be configured to receive and store other data, such as battery history data, that may be necessary for the renting, monitoring and recycling of the power supplying device 306, and the blockchain network may comprise additional nodes to store such data. In other embodiments, the blockchain network 101 may not comprise a battery transaction node 309, battery status node 310 and/or wallet node 311. In some embodiments, one or more of the battery transaction node 309, battery status node 310, wallet node 311 and any other nodes of the blockchain network 101 may be integrated together.

In some embodiments, the blockchain network 101 may be a public ledger. This allows the information stored in the blockchain network 101 to be accessible to all and thus makes the stored information auditable and prevents unwarranted altering of the stored information. In other embodiments, the blockchain network 101 may be a private ledger, with access limited to certain groups, such as users 301, merchants 305 and recycling dealer 308 and buyers, that have been granted special permission. A private server requires less resources and cost to maintain as fewer copies of the ledger need to kept, but does not lose the data security benefits of a public ledger.

A user 301 can operatively interact with a user interface 302 that may include one or more of a smartphone, a tablet computer, a smart watch, a laptop computer, a desktop computer, or other similar Internet-enabled devices. The user interface 302 can be operatively configured to communicate with blockchain network 101 through the middleware server 303.

The middleware server 303 may be communicatively coupled to the blockchain network 101 and configured to send and retrieve data to and from the blockchain network and send commands to the blockchain network to store or retrieve such data. When the middleware server 303 receives a request from the user interface 302, merchant interface 304, recycler interface 307 or buyer interface to access information, the middleware server 303 may send a command to the blockchain network 101 to retrieve the relevant data and send it to the middleware server, and then the middleware server will relay the data to the respective interface. In some embodiments, the middleware server 303 is configured to send data, such as transaction records, battery status information and account information, to the blockchain network 101 for storage as soon as the middleware server 303 receives such data from the user interface 302, merchant interface 304, recycler interface 307, buyer interface or power supplying device 306. In other embodiments, the middleware server 303 is configured to send such data to the blockchain network 101 for storage at regular intervals, such as every hour, every 2 hours, every 6 hours, every 12 hours or every 24 hours.

Any data regarding the power supplying device 306, such as battery history data, which may include battery status information or transaction records, that is sent or retrieved from the blockchain network will have attached a unique identification number of the battery unit 503 of the relevant power supplying device. The battery history data may be utilized in any appropriate manner, for example, to generate a report by retrieving battery history data associated with the unique identification number of a particular battery unit 503.

The middleware server 303 may be in communication with the blockchain network 101 via any type of communications channel such as a local area network (LAN), wide area network (WAN), direct computer connections, and/or wireless connections using radio frequency, infrared, or other wireless technologies.

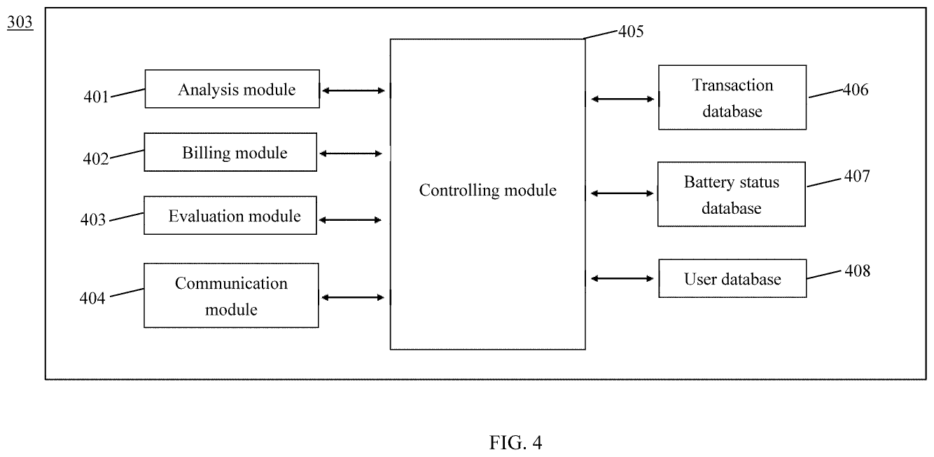

FIG. 4 illustrates the middleware server 303 of the system 300 in accordance with one embodiment of the present invention. The middleware server 303 comprises an analysis module 401, a billing module 402, an evaluation module 403, a communication module 404, a controlling module 405, a transaction database 406, a battery status database 407 and a user database 408. The embodiment described herein is only one representation of this aspect of the present invention. Other representations that vary from what is described herein exist. In this embodiment of the present invention, the transaction database 406 and battery status database 407 are illustrated as separate databases. It should be evident that in other embodiments of the present invention these databases may be combined into an integrated database having both the battery status datasets and the transaction records therein. In other embodiments, the transaction database 406, battery status database 407 and user database 408 are separate databases. In further embodiments, these databases may be combined into an integrated database.

The middleware server 303 can determine a need for the storage, transmission or computation of data, and can perform computations, store data or recall stored data. The middleware server 303 may communicatively couple to a power supplying device 306 through the communication module 404 of the middleware server. The middleware server 303 receives battery operation parameters from the power supplying device 306 via the communication module 404. The battery operation parameters may include the voltage, input and output (I/O) current and temperature of the power supplying device 306. The battery operation parameters can be recorded in the battery status database 407. In some embodiments, the controlling module 405 may be a microcontroller (MCU) or a microprocessor. The analysis module 401 can be configured to calculate battery status parameters of the power supplying device 306 based on the battery operation parameters. Once the battery status parameters are calculated, it can be recorded on to the battery status database 407. The evaluation module 403 can be configured to compute various monetary values of the power supplying device 306, such as the rental value, recycling price or sale price, based on the battery operation parameters and/or battery status parameters. In some embodiments, the analysis module 401 and the evaluation module 403 can be integrated together as a calculation module. In other embodiments, the analysis module 401 and the controlling module 405 are integrated together. Once the monetary values of the power supplying device 306 are evaluated, it can be recorded in the transaction database 406.

The controlling module 405 can assign the analysis module 401 with computing assignments and request the analysis module to provide information related to computation. In some embodiments, the analysis module 401 may be a computing device or digital computer, including laptops, desktops, workstations, servers, blade servers, mainframes, and other appropriate computers.

The battery status database 407 stores data including battery operation parameters and/or battery status parameters of the power supplying device 306. The transaction database 406 can store data such as transaction records, rental records, rental value, recycling price and sale price for each particular power supplying device 306. The user database 408 can store user information, including but not limited to user identification information and account balance. In some embodiments, the middleware server does not contain a user database 408 and does not store any user information. In an age where privacy is highly valued, it may be beneficial not to store any information that may identify the user.

The data stored in the transaction database 406, battery status database 407 and user database 408 all form part of the power supplying device's 306 battery history data, which provide information that may affect the market value of a used power supplying device. Such battery history data may include usage information such as total number of charge/discharge cycles, total time in charging process, safety inspection information, error/fault history, product recall history, number of owners, operation parameters, status parameters and any other information relevant to the power supplying device's 306 history or value. For example, if the power supplying device 306 is a vehicle battery, battery history data may also include the particular type of vehicle using the battery since particular types of vehicles can suggest severe usage, such as commercial vehicles.

In some embodiments, the transaction database 406, battery status database 407 and user database 408 are volatile memory units. In another embodiment, the transaction database 406, battery status database 407 and user database 408 are non-volatile memory units. In further embodiments, the transaction database 406, battery status database 407 and user database 408 comprise both volatile and non-volatile memory units. The transaction database 406, battery status database 407 and user database 408 can also be another form of computer-readable medium, e.g., a magnetic or optical disk. The middleware server 303 can receive and execute instructions from a user 301, a recycling dealer 308, merchant 305 and/or buyer of the power supplying device 306. The controlling module 405 can coordinate other modules in the middleware server 303, for example, for the computing, storage and transmission of data. The user can communicate wirelessly through the user interface 302. Such communication can occur, for example, through radio-frequency transceivers or using a Bluetooth®, Wi-Fi, or other such transceiver. The controlling module 405 has a processor and memory so as to perform functions including processing, data storage, communications and controls. The billing module 402 is configured to respond to a transaction request such as renting, returning, recycling and trading requests from a user 301, merchant 305 or recycling dealer 308. In response to a transaction request, the billing module 402 records relevant transaction information in the transaction database 406 and, if necessary, executes an electronic payment transaction at the middleware server 303. Such relevant transaction information may include rental start and end times, rental duration, rental value, rental price, recycling price and sale price etc.

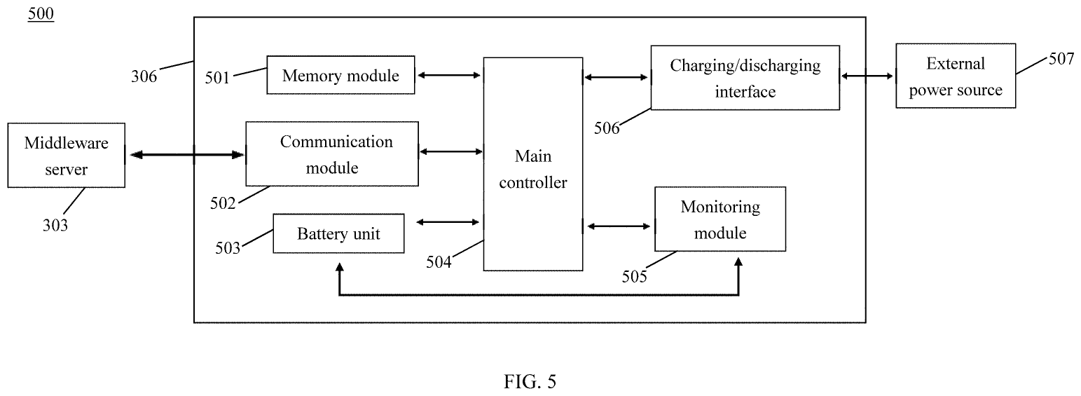

FIG. 5 shows a schematic representation of a system 500 for monitoring the power supplying device 306 according to an embodiment of present invention. In some embodiments, the power supplying device 306 comprises a memory module 501, a communication module 502, a battery unit 503, a main controller 504, a monitoring module 505, a charging/discharging interface 506 and an external power source 507. The monitoring module 505 can monitor the performance of the battery unit 503, and the communication module 502 can transmit and/or receive information to and from the middleware server 303. The monitoring module 505 may collect information and signals coming from the battery unit 503 and transmit said information and signals to the middleware server 303 via the communication module 502 according to an instruction from the main controller 504.

In some embodiments, the battery unit 503 of the power supplying device 306 includes at least one anode, at least one cathode, and at least one dividing layer disposed between the at least one anode and the at least one cathode. In certain embodiments, the battery unit 503 of the power supplying device 306 includes an anode, a cathode, and a dividing layer disposed between the anode and the cathode. In certain embodiments, the at least one anode and the at least one cathode are in the form of sheets. In certain embodiments, the at least one anode and the at least one cathode are wrapped in a spiral configuration and disposed within an electrolyte.

In some embodiments, the dividing layer is a separator. In certain embodiments, the separator is made of polymeric fibers selected from the group consisting of polyolefin, polyethylene, high-density polyethylene, linear low-density polyethylene, low-density polyethylene, ultrahigh-molecular-weight polyethylene, polypropylene, polypropylene/polyethylene co-polymer, polybutylene, polypentene, polyacetal, polyamide, polycarbonate, polyimide, polyetherether ketone, polysulfones, polyphenylene oxide, polyphenylene sulfide, polyacrylonitrile, polyvinylidene fluoride, polyoxymethylene, polyvinyl pyrrolidone, polyester, polyethylene terephthalate, polybutylene terephthalate, polyethylene naphthalene, polybutylene naphthalate, and combinations thereof. In certain embodiments, the separator may be coated with one or more inorganic layers to improve its mechanical strength. In some embodiments, the one or more inorganic layers may comprise a metal oxide selected from the group consisting of Al₂O₃, SiO₂, TiO₂, ZrO₂, BaOₓ, ZnO, CaCO₃, TiN, AlN, MTiO₃, K₂O.nTiO₂, Na₂O.mTiO₂ and combinations thereof, wherein x is 1 or 2; M is Ba, Sr or Ca; n is 1, 2, 4, 6 or 8; and m is 3 or 6.

In some embodiments, the dividing layer is a solid electrolyte. In certain embodiments, the solid electrolyte is a glass material, a ceramic material or a polymer gel. In some embodiments, the glass material or ceramic material is a metal oxide, sulfide, phosphate or a combination thereof. In certain embodiments, the metal is selected from the group consisting of Li, Na, Fe, Zn, Zr, Ti, Al, La, Ce, Y, Ga, Ge, Ca, Sr and combinations thereof. In certain embodiments, the polymer gel comprises a non-aqueous electrolyte solution trapped in a polymer matrix.

Electrical power may be transferred to and extracted from the battery unit 503 via the positive terminal and the negative terminal. It should be appreciated that the battery unit 503 may be of any suitable storage configuration, such as lithium-ion, nickel metal-hydride, lead-acid, metal-air, lithium metal, lithium polymer, solid state, or any other type of rechargeable battery.

To enhance its safety, the power supplying device 306 may further comprise a locking module, which stops all activity of the power supplying device 306 if it receives an alert signal from the middleware server 303 or main controller 504 indicating that the battery unit 503 has deviated from normal operating conditions, i.e. one or more parameters have exceeded a predetermined normal range. In some embodiments, the locking module is coupled to the battery unit 503. In certain embodiments, the locking module is coupled to the charging/discharging interface 506. In some embodiments, the locking module is configured to disable the charging/discharging interface if the battery unit 503 has deviated from normal operating conditions.

In certain embodiments, the memory module 501, battery unit 503, main controller 504, monitoring module 505 and communication module 502 may be electronically connected. In some embodiments, the main controller 504 is electronically connected to the monitoring module 505 and the communication module 502. In certain embodiments, the monitoring module 505 is electronically connected to the battery unit 503.

In some embodiments, the battery unit 503 provides power to various components of the power supplying device 306 so that the monitoring module 505 can monitor the performance of the battery unit 503, and the communication module 502 can transmit and/or receive information to and from the middleware server 303. The monitoring module 505 may collect information and signals coming from the battery unit 503 and transmit said information and signals to the main controller 504. In some embodiments, the main controller 504 is further configured to allocate power to various modules of the power supplying device 306.

In some embodiments, the battery operation parameters include voltage, input and output (I/O) current and temperature of the battery unit 503. In some embodiments, the monitoring module 505 includes a temperature sensor communicatively coupled to the battery unit 503 for monitoring its temperature. In certain embodiments, the temperature sensor is a thermocouple. By placing the temperature sensor in direct contact with the exterior surface of the battery unit 503, the temperature sensor may accurately measure the battery unit's 503 temperature. In some embodiments, the monitoring module 505 includes a voltmeter and/or an ammeter coupled to the battery unit 503 and is configured to monitor the voltage and current of the battery unit. Such information may be useful for diagnosing faults within the battery unit 503. In certain embodiments, the monitoring module 505 may include other sensors so as to monitor any other parameters that may be relevant.

In some embodiments, the monitoring module 505 and/or the main controller 504 may also have memory that is configured to store past values of the measured battery operation parameters. For example, the memory may store the maximum voltage measured by the voltmeter and/or the maximum temperature measured by the temperature sensor. Furthermore, the memory may be configured to store usage information, such as average load, maximum load, duration of operation, or other parameters that may be useful for monitoring the status of the battery unit 503. The battery unit 503 may also have identification information, such as the unique identification number associated with the battery unit, that is stored within the memory of the monitoring module 505 and/or the main controller 504. In such a configuration, the unique identification number would be attached to any information or data sent to or received from the middleware server 303, so that the middleware server may identify a particular battery unit 503 based on the unique identification number, thereby facilitating communication between the power supplying device 306 and the middleware server 303.

In addition, the monitoring module 505 may also be configured to measure the state of charge within the battery unit 503 (e.g., via monitoring an ion concentration) by positioning a measuring device adjacent the anode and cathode. The measuring device may include a sensor coupled to the anode and the cathode, and configured to directly measure the charge on the anode and cathode. As a result, an accurate state of charge may be determined. The measuring device may also be configured to measure properties of the electrolyte, such as pH.

In some embodiments, the measuring device in the monitoring module includes a voltmeter. In some embodiments, the measuring device includes a voltmeter and a temperature sensor. In certain embodiments, the measuring device may include additional sensors configured to monitor other battery operation parameters of the battery unit 503. For example, in certain embodiments, the measuring device may include a pressure sensor configured to detect the pressure within the battery unit 503. In yet further embodiments, the measuring device may include an ammeter, an ohmmeter, or other sensors configured to monitor an electrical, physical or chemical parameter of the battery unit 503. The sensors may be coupled to the exterior or interior surface of the battery unit 503.

In certain embodiments, a set of sensors are coupled to the battery unit 503 to provide readings of various battery operation parameters to the monitoring module 505. In one embodiment, there is a current sensor, a battery voltage sensor, a battery midpoint voltage sensor, and a temperature sensor. In some embodiments, the monitoring module 505 can also monitor the charge/discharge cycles of the battery unit 503. The present invention allows an accurate prediction of the state of health of the battery unit 503 to be generated from a small number of parameters. This decreases the amount of data to be polled, processed and stored by the system.

In some embodiments, the main controller 504 may be a microcontroller (MCU) or microprocessor that reads all communications arriving from the monitoring module 505, processes this data and sends communication signals with the processed data to the middleware server 303 via the communication module 502. In some embodiments, the main controller 504 may store the processed data. In other embodiments, the processed data may be stored in the memory module 501.

In some embodiments, the monitoring module 505 may be configured to multiplex a voltage signal and a temperature signal, and to transmit the multiplexed signal to the main controller 504. In alternative embodiments, the voltage signal and the temperature signal may be transmitted sequentially (e.g., voltage signal first and temperature signal second). Additional battery operation parameters (e.g., pressure, amperage, resistance etc.) may be included in the multiplexed signal. In some embodiments, the monitoring module 505 may store those information and signals. In certain embodiments, the measured battery operation parameters may be accumulated and stored in the memory module 501 for future transmission. In other embodiments, the measured battery operation parameters may instead be accumulated and stored in the memory of the monitoring module 505 and/or the main controller 504 for future transmission.

In certain embodiments, the main controller 504 may be configured to process the measured battery operation parameters, calculate the battery status parameters and multiplex the computed battery status parameters. Status parameters of the battery unit 503 may include state of charge of the battery unit and cumulative capacity of the battery unit. The multiplexed signal can then be transmitted to the communication module 502. In some embodiments, the communication module 502 may be configured to multiplex the battery operation parameters and status parameters, and to transmit the multiplexed signal to the middleware server 303. In alternative embodiments, the battery operation parameters and status parameters may be transmitted sequentially. In certain embodiments, the computed battery status parameters may be accumulated and stored in the memory module 501 for future transmission.

In some embodiments, the information and signals transmitted between the power supplying device 306 and the middleware server 303 may be encrypted. This provides better protection of sensitive information such as identification information. The controlling module 405 of the middleware server 303 and the main controller 504 of the power supplying device 306 may be configured to encrypt and/or decrypt signals.

In certain embodiments, the communication module may be configured to transmit multiple signals indicative of multiple parameters simultaneously or sequentially. In certain embodiments, the communication module 404 of the middleware server 303 and the communication module 502 of the power supplying device 306 may be a Wi-Fi network, Bluetooth or any other means that can connect to the middleware server. In certain embodiments, the communication module 502 of the power supplying device 306 may include a location tracking function, such as via GPS.

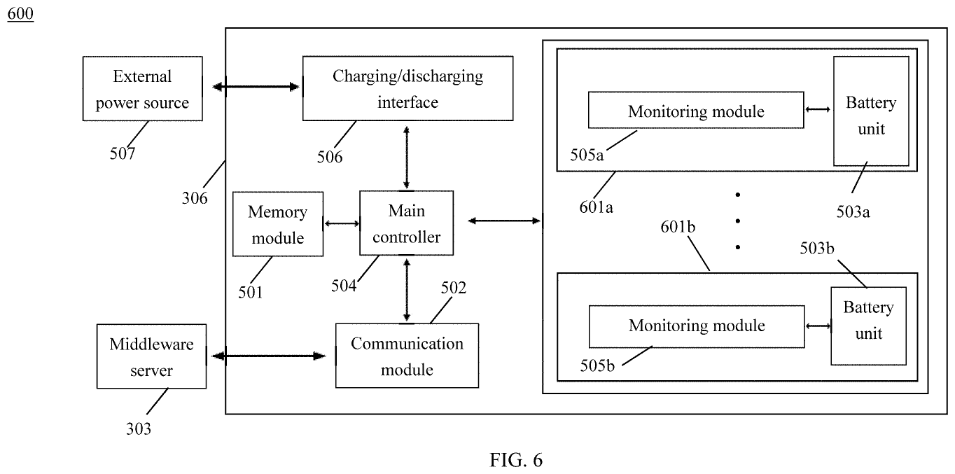

FIG. 6 shows a schematic representation of a system 600 for monitoring the performance of individual battery cells 601a and 601b in a power supplying device 306 comprising a plurality of battery cells according to an embodiment of present invention. The power supplying device 306 may comprise a plurality of battery cells 601a and 601b electrically connected to each other. The connection or arrangement of the battery cells 601a and 601b is not particularly restricted so long as the battery cells are connected to have a structure that is capable of providing good performance. The battery cells 601a and 601b may be connected in parallel, in series, or in parallel and series to each other depending on voltage and storage capacity requirements. There are no particular limitations on the number of battery cells 601 in a particular power supplying device 306; as many as needed to fulfill the requirements of the intended application may be used. In some embodiments, the power supplying device 306 comprises two or more battery cells 601a and 601b, such as 3, 4, 5, 6, 7, 8, 9 or 10 battery cells. In certain embodiments, the power supplying device 306 comprises between 5 and 10 battery cells, between 5 and 15 battery cells, between 5 and 20 battery cells, between 5 and 50 battery cells, between 5 and 100 battery cells, between 5 and 500 battery cells, between 5 and 800 battery cells and between 5 and 1000 battery cells.

Each battery cell 601 in the power supplying device 306 comprises a monitoring module 505 and a battery unit 503. Therefore, each individual battery cell 601 can be monitored and performance data of each battery cell can be obtained. To minimize the size of the power supplying device 306, it is preferable to send the measured battery operation parameters to the middleware server 303 for calculating the battery status parameters. The monitoring modules 505 can transmit the information and signals to the middleware server 303 via the communication module 502 after collecting information and signals coming from each individual battery unit 503 in the power supplying device 306.

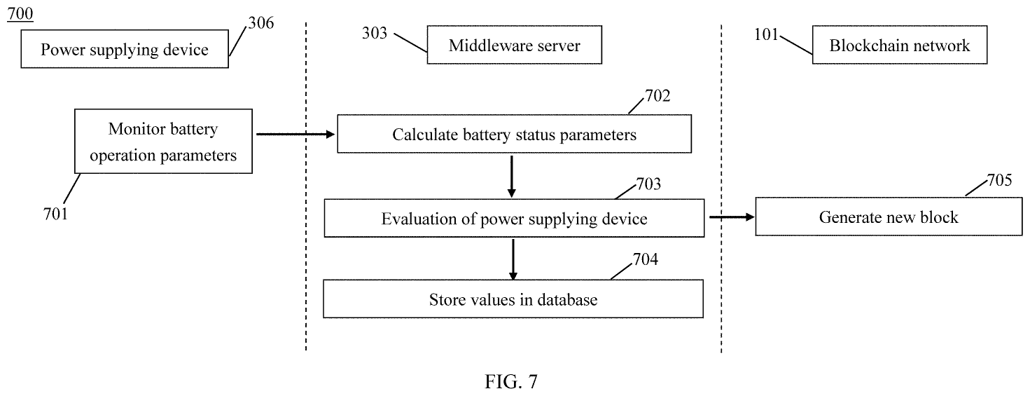

FIG. 7 illustrates a method 700 to monitor the status and evaluate the value of a power supplying device 306 in accordance with one embodiment of the present invention. The method 700 comprises a power supplying device 306, middleware server 303 and blockchain network 101.

The monitoring module 505 of the power supplying device 306 may collect battery operation parameters coming from the battery unit 503 of the power supplying device and transmit said battery operation parameters to the middleware server 303. The middleware server 303 receives battery operation parameters from the power supplying device 306. Battery status parameters can then be calculated based on the battery operation parameters. In some embodiments, the battery status parameters comprise the state of capacity (SOC) and state of health (SOH) of the battery.

Once the battery status parameters are calculated, various monetary values of the power supplying device 306, such as the rental value, recycling price or sale price, can be evaluated based on the battery operation parameters and/or battery status parameters. The various monetary values may then be stored in a database in the middleware server 303. In certain embodiments, the monetary values may also be stored in a node of the blockchain network 101 by generating a new block in the blockchain network. In some embodiments, the battery operation parameters and/or battery status parameters may also be stored in the middleware server 303 and/or blockchain network 101.

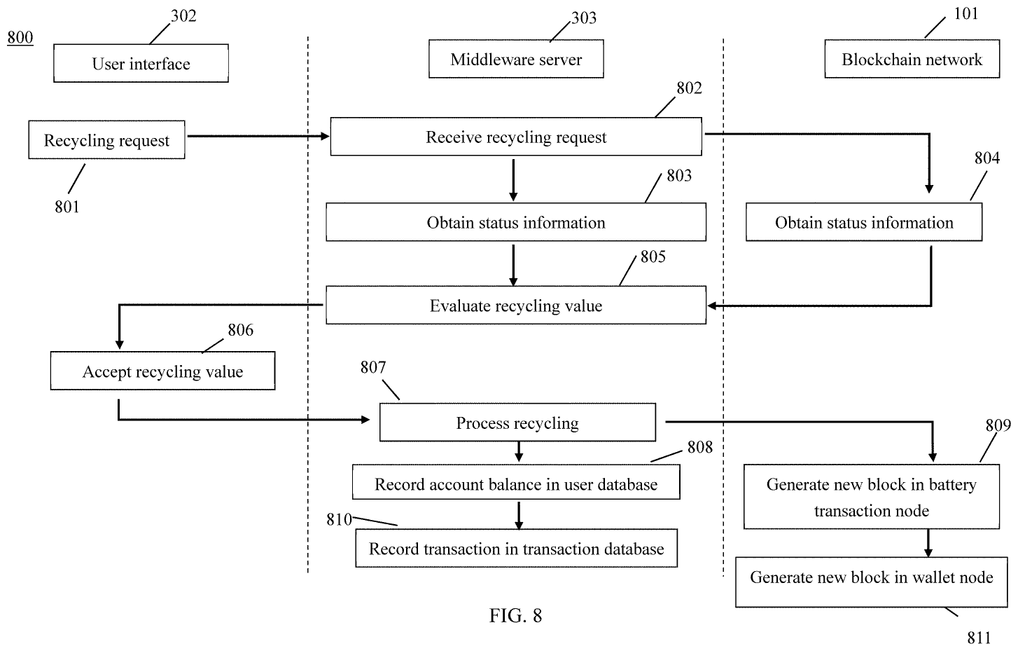

FIG. 8 shows a method 800 for recycling a power supplying device 306 in accordance with one embodiment of the present invention. A user 301 may send a request to recycle a power supplying device 306 via the user interface 302. The middleware server 303 receives the recycling request and may then obtain status information of the power supplying device 306 from the battery status database 407 and/or battery status node 310. The middleware server 303 may then use said status information to evaluate the recycling price of the power supplying device 306. The user 301 is shown the recycling price via the user interface 302 and, once the user accepts the recycling price, the middleware server 303 may then credit the recycling price to the user's 301 account and the user's new balance is recorded in the user database 408 and/or wallet node 311. The middleware server 303 may make a record in the transaction database 406 and/or battery transaction node 309 that the power supplying device 306 has been recycled by generating new blocks/entries in the respective nodes/databases. Such generation of new blocks/entries in the user database 408/wallet node 311 and in the transaction database 406/battery transaction node 309 can be performed simultaneously or sequentially in any order.

In certain embodiments, battery history data in the middleware server 303 and/or blockchain network 101 may be accessed and used in evaluating the recycling price of the power supplying device 306. In some embodiments, the health of the power supplying device is not considered when evaluating the recycling price and a fixed price is offered to the user. In further embodiments, the user 301 and/or the recycling dealer 308 may adjust or negotiate the recycling price via the user interface 302 and/or recycler interface 307 respectively before the recycling price is accepted by the user.

In other embodiments, the request to recycle may be issued by a merchant 305 via a merchant interface 304 instead of a user 301 via a user interface 302. This may happen when the merchant 305 simply decides to recycle the power supplying device 306, or when the merchant is alerted by the monitoring system 500 that the power supplying device has been deemed unsafe or defective, as well any other scenario where the merchant would voluntarily recycle the device. In some embodiments, the middleware server 303 will analyze the status information to determine the health of the power supplying device 306 and decide if the power supplying device is fit for further use, such as further rental or resale. In other embodiments, the middleware server 303 will not analyze the status information and the power supplying device 306 will be recycled regardless of its health.

In some embodiments, the middleware server 303 may transmit any information processed during any one or more steps of the method 800 to the merchant interface 304 and/or recycler interface 307 to alert the merchant 305 and/or the recycling dealer 308 of the transaction.

By giving credit to the user 301, the method 800 of the present invention provides a strong incentive that encourages recycling of power supplying devices 306. When combined with the monitoring system 500, the present invention allows the status of the power supplying device 306 to be continuously monitored and the user 301 to be constantly aware of the health of the power supplying device. This prevents premature recycling, thus maximizing the lifetime of the devices, reducing waste and costs, and increasing the efficiency of the use of power supplying devices. Even if a user 301 prematurely requests the recycling of a power supplying device 306, the present invention is able to determine which power supplying devices are healthy enough for more use, further reducing waste and increasing the efficiency of use.

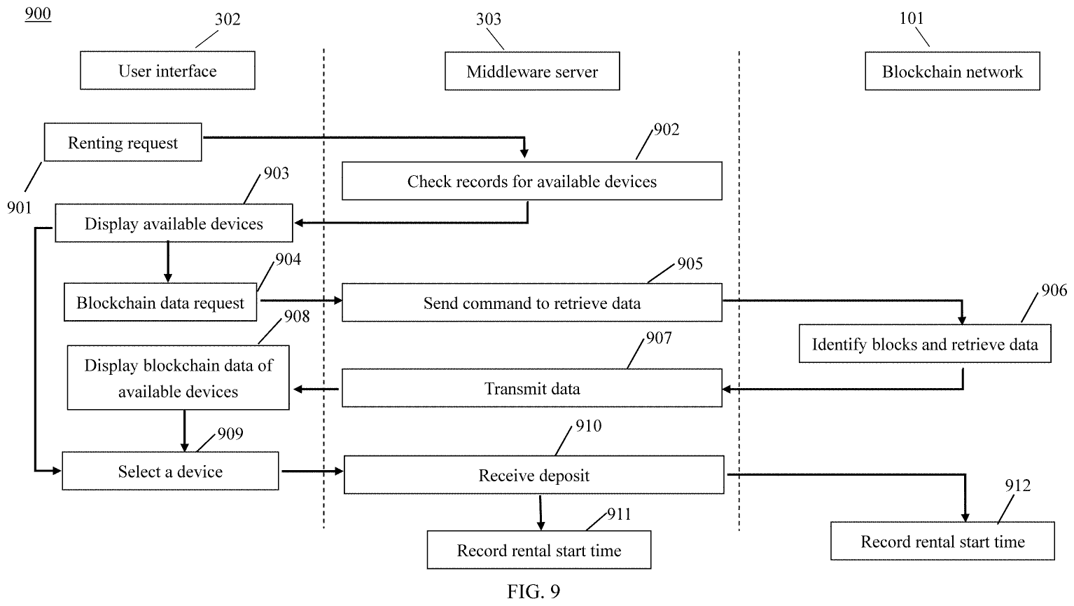

FIG. 9 illustrates a rental method 900 in accordance with one embodiment of the present invention. The rental method 900 comprises a user interface 302, middleware server 303 and blockchain network 101.

A user 301 may rent a power supplying device 306 via the rental method 900. The user 301 may send a renting request to the middleware server 303 via the user interface 302. The middleware server 303 may then check for available power supplying devices 306 by retrieving status and transaction records of power supplying devices from its databases, and then transmit information, such as rental value and location information, of available power supplying devices to the user interface 302. The user interface 302 will display such information and the user 301 may then select to rent an available device 306 via the user interface. After the middleware server 303 receives the selection of a device 306, the middleware server will check whether the user 301 has sufficient balance in the account for a deposit by retrieving data from the user database 408 and/or the wallet node 311. If insufficient, the user 301 can pay for the deposit by any other payment methods, such as a credit card. After receiving the deposit, the middleware server 303 will record the rental start time in the middleware server 303 and/or the blockchain 101. In certain embodiments, a deposit is not a prerequisite for renting a power supplying device 306. In some embodiments, the middleware server 303 may transmit any information processed during any one or more steps of the method 900 to the merchant interface 304 to alert the merchant 305 of the transaction. In further embodiments, the merchant 305 may adjust the rental value or the deposit amount via the merchant interface 304 before the user 301 pays the deposit.

Before selecting a power supplying device 306, the user 301 may also request to check past records of a particular available device. The user 301 may file a request to the middleware server 303 via the user interface 302 to review the data recorded in the blockchain network 101. The middleware server 303 will receive the request and thus generate and send a command to the blockchain network 101 to retrieve the relevant data. In particular, the command may be generated by the controlling module 405 of the middleware server 303. The retrieved battery history data may then be sent to the middleware server 303 and further transmitted to the user interface 302 to be displayed, for example, as a battery history report. The user 301 may then select an available device 306 and the method 900 proceeds as above.

The rental price of a power supplying device 306 can be calculated based on, but not limited to, the type of the power supplying device, value, and/or rental price for similar products previously entered into the system. The rental price may also be calculated based on the battery history data of the power supplying device 306. In certain embodiments, the rental price is a fixed price that is not calculated based on the battery history data of the power supplying device 306.

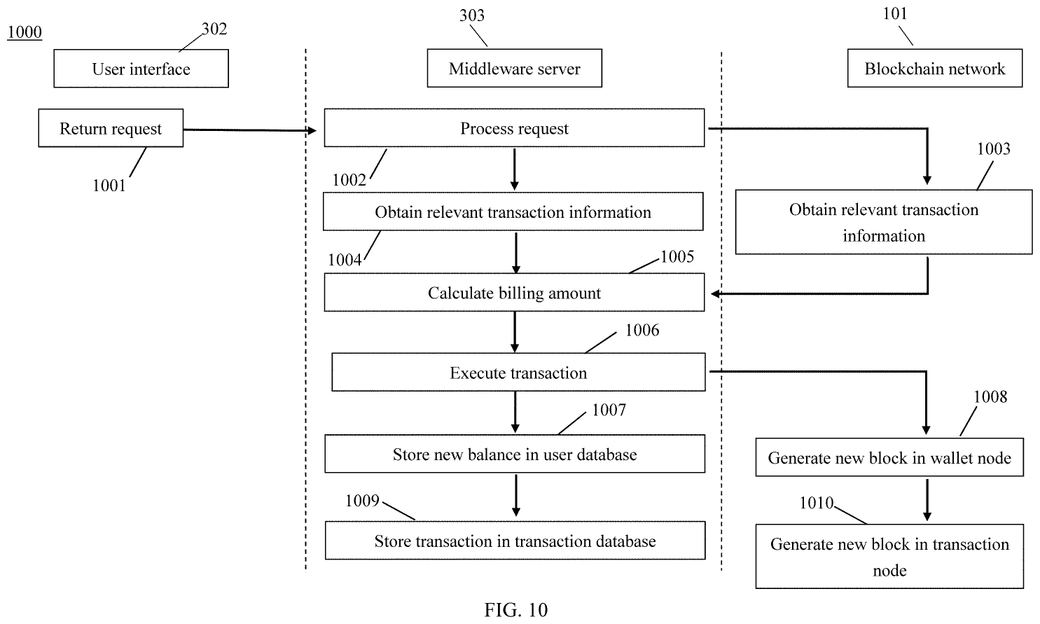

FIG. 10 shows a method for returning a power supplying device 306 in accordance with one embodiment of the present invention. When the user 301 returns the power supplying device 306, the user will send a return request 1001 to the middleware server 303 via the user interface 302. The billing module 402 then obtains the relevant transaction information from the transaction database 406 and/or the battery transaction node 309 and generates a billing amount based on the rental price, the relevant transaction information, such as the rental duration, and possibly other information, such as the battery status information of the power supplying device 306. The billing module 402 will execute the transaction by debiting the billing amount from an account of the user 301. This billing amount may be expressed in a real currency or in a virtual currency such as credits or points awarded to users 301. The rental duration can be expressed in hours, days, weekends, weekdays, or other lengths of time. In some embodiments, the billing amount can be a predetermined price based on a rental duration previously selected by the user 301. In certain embodiments, the merchant 305 may adjust the rental price, such as apply discounts, via the merchant interface 304 before the user 301 pays the rental price. The new balance of the user's 301 account may then be recorded in the user database 408 and/or wallet node 311, and the transaction may be recorded in the transaction database 406 and/or battery transaction node 309. In some embodiments, the middleware server 303 may transmit any information processed during any one or more steps of the method 1000 to the merchant interface 304 to alert the merchant 305 of the transaction.

In some embodiments, the middleware server 303 may also evaluate the health of the power supplying device 306 based on battery history data such as battery operation parameters and status parameters. The middleware server 303 may then determine whether the power supplying device 306 is fit for further use. If not, the power supplying device 306 may be recycled, the process of which is discussed in further detail below. If the power supplying device 306 is deemed fit for further use, the middleware server 303 may evaluate the new rental or sale price of the power supplying device 306 for subsequent rental or sale. The evaluated health data may be stored in the battery status database 407 and/or battery status node 310, and the new rental or sale price may be stored in the transaction database 406 and/or battery transaction node 309 by generating new blocks/entries in the respective nodes/databases. Such generation of new blocks/entries in the battery status database 407/battery status node 310 and in the transaction database 406/battery transaction node 309 can be performed simultaneously or sequentially in any order.

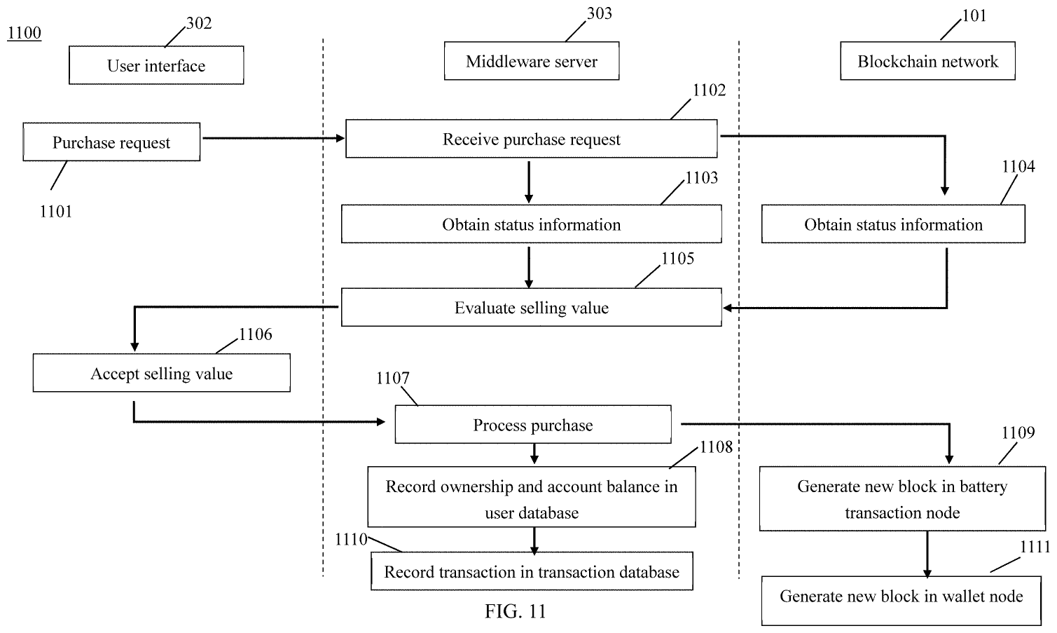

FIG. 11 shows a method 1100 for purchasing a power supplying device 306 in accordance with one embodiment of the present invention. A user 301 may send a request to purchase a power supplying device 306 via the user interface 302. The middleware server 303 receives the purchase request and may then obtain status information of the power supplying device 306 from the battery status database 407 and/or battery status node 310. The middleware server 303 may then use said status information to evaluate the sale price of the power supplying device 306. The user 301 is shown the sale price via the user interface 302 and, once the user accepts the sale price, the middleware server 303 may then debit the sale price to the user's 301 account and the user's new balance is recorded in the user database 408 and/or wallet node 311. The user database 408 and/or wallet node 311 may also be updated to reflect the new ownership information. The middleware server 303 may make a record in the transaction database 406 and/or battery transaction node 309 that the power supplying device 306 has been sold. All such recordation steps may be performed simultaneously or sequentially in any order.

In certain embodiments, the health of the power supplying device 306 is not considered when evaluating the selling price and a fixed price is offered to the user. In further embodiments, the user 301 and/or merchant 305 may adjust or negotiate the sale price via the user interface 302 and/or merchant interface 304 respectively before the sale price is accepted by the user. In some embodiments, the middleware server 303 may transmit any information processed during any one or more steps of the method 1100 to the merchant interface 304 to alert the merchant 305 of the transaction.

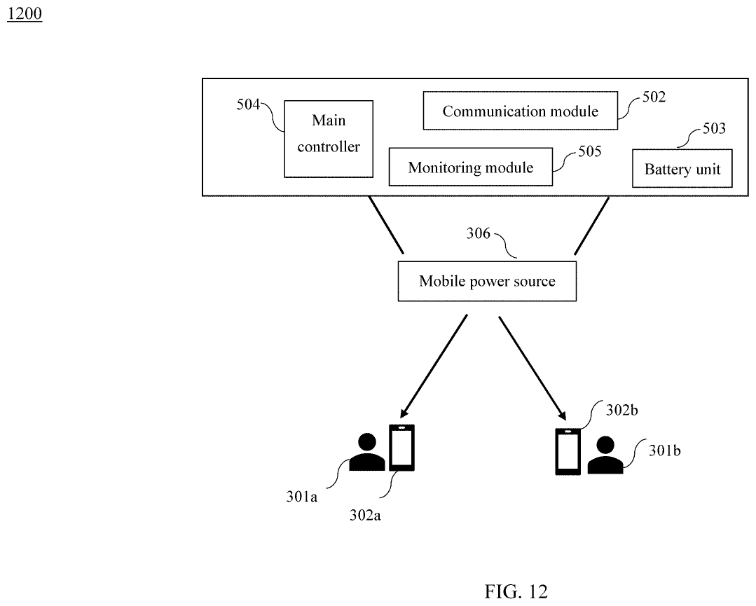

FIG. 12 shows the trading system 1200 in accordance with one example embodiment of the present invention. A user 301a may transfer a rented power supplying device 306 or sell a power supplying device they currently own to another user 301b via the system 1200. The user 301a may make a trading request, selecting either rental transfer or sale and specifying the other user 301b/user interface 302b, to the middleware server 303 via the user interface 302a. The middleware server 303 receives the trading request and establishes a connection with the other user interface 302b. In some embodiments, the trade is a rental transfer and the middleware server 303 may process the return of the power supplying device 306 for user 301a as described in method 1000, then process the rental of the same power supply device for user 301b as described in method 900 (in the case of a rental transfer). In other embodiments, the trade is a sale of the power supplying device 306 from user 301a to user 301b and the middleware server 303 process a purchase for user 301b according to the method 1100, wherein the sale price deducted from the user's 301b account is transferred to the user's 301a account and additional transaction and ownership records reflecting credit in user's 301a balance and user's 301a loss of ownership are stored in the relevant databases/nodes of the middleware server 303 and/or blockchain network 101 as described in method 1100.

In certain embodiments, the sale price of the power supplying device 306 is determined by the middleware server 303 using battery history information in accordance with the method 1100. In other embodiments, the sale price of the power supplying device 306 is specified by the user 301a by entering it into the user interface 302a. In some embodiments, the user 301a specifies the other user 301b by supplying the middleware server 303 with account or identification information of user 301b. In certain embodiments, the account or identification information of user 301b may be in the form of a scannable barcode. In other embodiments, the user 301a specifies the user interface 302b via a mutual wireless connection between the two user interfaces 302a and 302b, such as Wi-Fi or Bluetooth.

In some embodiments, the middleware server 303 will request data from the blockchain network 101 for analyzing the updated status and/or health conditions of the power supplying device 306 when the user 301 trades the power supplying device. The controlling module 405 of the middleware server 303 compares the received battery operation parameters, status parameters and/or evaluated data to the predetermined normal range. If the values of these parameters or evaluated data deviate from the predetermined normal range, the power supplying device 306 can be traded at a fixed price that has been previously decided for power supplying devices of the same or a similar condition.

When the user 301 wants to trade the power supplying device, the middleware server 303 will request data from the blockchain network 101 for analyzing the updated status of the power supplying device 306. The analysis module 401 of the middleware server 303 compares the received battery operation parameters and status parameters to the predetermined normal range. If the values of the status parameters deviate from the predetermined normal range, the power supplying device 306 can be recycled at a fixed price that has been previously decided for power supplying devices of the same or a similar condition.

In general, in the methods 800, 900, 1000 and 1100, the middleware server 303 may transmit any information that it receives, whether from a power supplying device 306 or from a user 301, to the blockchain network 101 for recording. In some embodiments, the middleware server 303 transmits all of the information it receives from a power supplying device 306 or a user 301 to the blockchain network 101 for recording. In other embodiments, the middleware server 303 transmits only some of the information it receives from a power supplying device 306 or a user 301 to the blockchain network 101 for recording. In certain embodiments, the middleware server 303 stores the information that is not transmitted to the blockchain network 101 for recording. In certain embodiments, the middleware server 303 does not transmits any user identification information to the blockchain network 101 for recording. Since information on the blockchain network 101 cannot be changed or deleted, not storing any user identification information on it may be advantageous from a data protection point of view.

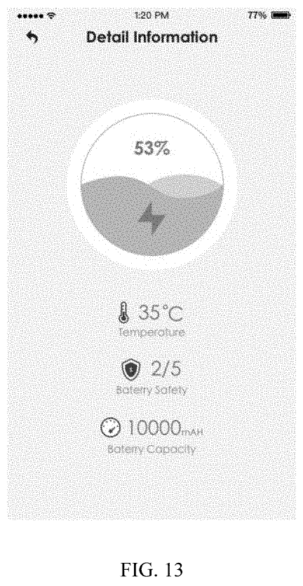

FIG. 13 is a representation of the user interface 302 according to one embodiment of the present invention. In some embodiments, the user interface 302 may display battery status information (such as remaining capacity and battery internal temperature), transaction information (such as remaining time in rental period and current rental price) and/or user information (such as current account balance).

While the invention has been described with respect to a limited number of embodiments, the specific features of one embodiment should not be attributed to other embodiments of the invention. In some embodiments, the methods and systems may include numerous steps and components not mentioned herein. In other embodiments, the methods and systems do not include, or are substantially free of, any steps and components not enumerated herein. Variations and modifications from the described embodiments exist. The appended claims intend to cover all those modifications and variations as falling within the scope of the invention.

1. A method for managing a power supplying device on a blockchain-based system, the method comprising:
(a) inputting a user identification, an existing product identification and a data retrieval instruction to a middleware computer;
(b) verifying the user identification via the middleware computer;
(c) retrieving, from existing blocks in a blockchain ledger, one or more virtual folders that are associated with the product identification;
(d) transmitting the one or more virtual folders to the middleware computer;
(e) extracting recorded characteristic data from the one or more virtual folders using the middleware computer;
(f) verifying the recorded characteristic data;
(g) inputting new characteristic data into the middleware computer;
(h) generating, via the middleware computer, a new product identification that is connected to the existing product identification;
(i) linking, via the middleware computer, the new product identification and the new characteristic data to form a new virtual folder;
(j) transmitting the new virtual folder from the middleware computer to the blockchain ledger; and
(k) creating a new block in the blockchain ledger to record the new virtual folder.

2. The method of claim 1, wherein the user identification comprises a user classification and the one or more virtual folders retrieved in step (c) are further associated with the user classification.

3. The method of claim 2, wherein step (b) further comprises determining access restrictions of the user classification, and the one or more virtual folders of step (c) are associated with the user classification by virtue of the one or more virtual folders being accessible under the access restrictions of the user classification.

4. The method of claim 1, wherein step (f) is performed by the middleware computer, and the new virtual folder of step (i) is formed by further linking the new product identification and the new characteristic data with the user identification; and wherein the new product identification of step (h) is further connected to one or both of the user identification and the new characteristic data.

5. (canceled)

6. The method of claim 1, wherein each of the recorded characteristic data and the new characteristic data independently comprise a product source, a product brand, a product type, a product size or combinations thereof.

7. The method of claim 1, wherein step (f) further comprises producing a verification result, transmitting the verification result from the middleware computer to the blockchain ledger and recording the verification result in the blockchain ledger.

8. The method of claim 7, wherein step (f) further comprises issuing a reward once the verification result is recorded in the blockchain ledger.

9. The method of claim 1, wherein step (k) further comprises issuing a reward once the new virtual folder is recorded in the blockchain ledger.

10. A blockchain-based tracking system for managing a power supplying device, comprising:
a blockchain, and
one or more middleware computers that are capable of:
receiving one or more virtual folders from a blockchain;
extracting recorded characteristic data from the one or more virtual folders;
verifying a user identification and the recorded characteristic data;
generating a new product identification that is connected to an existing product identification;
linking the new product identification and new characteristic data to form a new virtual folder;
transmitting the new virtual folder to the blockchain; and
creating a new block in the blockchain to record the new virtual folder.

11. The system of claim 10, wherein the one or more middleware computers are accessible by a plurality of users, with each user belonging to a sector.

12. The system of claim 11, wherein the sectors comprise one or more of a raw material sector, a cell manufacturing sector, a pack manufacturing sector, a battery manufacturing sector, a consumer sector and a recycling sector.

13. A blockchain-based renting and monitoring system for a power supplying device comprising:
a blockchain ledger;
a middleware server configured to transmit data to and receive data from the blockchain ledger;
a mobile terminal comprising a renting module configured to transmit an instruction to the middleware server to rent the power supplying device; and
a power supplying device comprising:
a battery;
a monitoring module coupled to the battery and configured to monitor one or more battery operation parameters;
a main controller coupled to the monitoring module and configured to calculate one or more battery status parameters using the one or more battery operation parameters received from the monitoring module; and
a communication module coupled to the main controller and configured to transmit the one or more battery operation parameters and battery status parameters to the middleware server.

14. The system of claim 13, wherein the mobile terminal further comprises a returning module configured to transmit an instruction to the middleware server to return the power supplying device.

15. The system of claim 14, wherein the middleware server comprises a billing module for calculating the rental fee of the power supplying device.

16. The system of claim 13, wherein the one or more battery operation parameters comprise:
a battery voltage;
an internal battery temperature;
an I/O current of the battery; and
the number of charge/discharge cycles of the battery.

17. The system of claim 13, wherein the one or more battery status parameters comprise:
a state of charge of the battery;
a battery capacity; and
cumulative capacity of the battery.

18. The system of claim 13, wherein the communication module comprises a Bluetooth transceiver or a Wi-Fi transceiver; and wherein the power supplying device further comprises a locking module to disable charging/discharging of the battery.

19. (canceled)

20. The system of claim 13, wherein the middleware server comprises:
a communication module configured to receive the one or more battery operation and status parameters;
an analysis module configured to:
compare the one or more battery operation parameters and status parameters to a predetermined normal range to determine if the battery is operating under normal conditions, and
generate an alarm signal to return the power supplying device when the status parameters are outside the predetermined normal range;
a verification module configured to:
verify the identity of a user and check that the balance of the user's account contains sufficient credits to allow a deposit to be deducted, and
create an authorization instruction to allow the verified user to rent the power supplying device if the battery is operating under normal conditions; and
a memory module configured to record the one or more battery operation and status parameters, and the rental duration of the power supplying device.

21. The system of claim 19, wherein the locking modules is configured to disable charging/discharging of the battery when the one or more status parameters are outside the predetermined normal range.

22. The system of claim 20, wherein the memory module is further configured to record the number of charging/discharging cycles of the battery.
